(19) United States
(12) Patent Application Publication
(10) Pub. No.: US 2026/0233332 A1
(43) Pub. Date: Aug. 13, 2026

(54) LASER DOUBLE-SIDED WELDING DEVICE AND LASER DOUBLE-SIDED WELDING METHOD THEREFOR

(71) Applicant: CRRC QINGDAO SIFANG CO., LTD., Shandong (CN)

(72) Inventors: Xiaohui HAN, Shandong (CN); Shuaizhen LI, Shandong (CN); Gangqing LI, Shandong (CN); Yin MA, Shandong (CN)

(21) Appl. No.: 19/159,954

(22) PCT Filed: Jun. 24, 2020
(86) PCT No.: PCT/CN2020/097925

§ 371 Date: Aug. 26, 2025

(30) Foreign Application Priority Data
Jul. 19, 2019 (CN) 201910654251.4

(51) Int. Cl. B23K 26/08; B23K 26/10; B23K 26/21

(52) U.S. Cl. CPC B23K 26/0869; B23K 26/10; B23K 26/21

(57) ABSTRACT

A laser double-sided welding device for welding an upper surface and a lower surface of a butt weld between a first to-be-welded test piece and a second to-be-welded test piece, comprising: a controller, a first laser welding torch and a second laser welding torch, wherein the first laser and second welding torches are both connected to the controller, the first laser welding torch is arranged above the butt weld and is aligned with the upper surface of the butt weld, and the second laser welding torch is arranged below the butt weld and is aligned with the lower surface of the butt weld; and wherein the controller respectively controls the first laser welding torch and the second laser welding torch to synchronously move in a lengthwise direction of the butt weld and alternately perform welding on the upper surface and the lower surface of the butt weld.

### CROSS-REFERENCES TO RELATED APPLICATIONS

The present application claims priority to the Chinese patent application No. 2019106542514, filed on Jul. 19, 2019, entitled “laser double-sided welding device and laser double-sided welding method therefor”, which is incorporated herein by reference in its entirety.

### FIELD

The present application relates to the field of laser double-sided welding, particularly to a laser double-sided welding device and a laser double-sided welding method therefor.

### BACKGROUND

At present, when welding large-format medium and thin plates, due to the difficulty of turning over the large-format medium and thin plates and the limitations of the process, single-sided welding is generally used for the welding of the medium and thin plates. One of the main welding problems during welding is welding deformation, i.e., welding deformation is obvious under the action of welding stress. Post-weld correction is required in most cases, which is time-consuming and laborious. Therefore, it has become the main problem restricting the welding of medium and thin plates.

### BRIEF SUMMARY

### Technical Problems

The purpose of the present application is to provide a laser double-sided welding device and a laser double-sided welding method therefor, so as to solve the technical problems that laser welding devices in the prior art usually only can realize single-sided welding, so that the welding heat cannot be symmetrically distributed, and the welding stress distribution is not uniform during welding, resulting in different welding shrinkage and welding deformation in different welding areas, as well as serious welding deformation.

### Technical Solutions

To solve the above technical problems, according to an embodiment of the present application, there is provided a laser double-sided welding device for welding an upper surface and a lower surface of a butt weld between a first to-be-welded test piece and a second to-be-welded test piece that are adjacent, including a controller, a first laser welding torch, and a second laser welding torch, in which both the first laser welding torch and the second laser welding torch are connected to the controller, the first laser welding torch is provided above the butt weld and aligned with the upper surface of the butt weld, and the second laser welding torch is provided below the butt weld and aligned with the lower surface of the butt weld, and in which the controller is configured to control the first laser welding torch and the second laser welding torch respectively to move synchronously along a length direction of the butt weld and alternatively weld the upper surface and the lower surface of the butt weld.

In an embodiment, an end point of a first length welded by the first laser welding torch along an upper surface of the length direction of the butt weld is a start point of a second length welded by the second laser welding torch along a lower surface of the length direction of the butt weld.

In an embodiment, the laser double-sided welding device further includes a first welding table and a second welding table provided adjacent to the first welding table, where the first welding table is configured to place the first to-be-welded test piece and the second welding table is configured to placing the second to-be-welded test piece, in which the butt weld between the first to-be-welded test piece and the second to-be-welded test piece is provided between the first welding table and the second welding table.

In an embodiment, the laser double-sided welding device further includes a laser electrically connected to the controller.

In an embodiment, the laser double-sided welding device further includes a first drive mechanism configured to drive the first laser welding torch to move along the length direction of the butt weld.

In an embodiment, the laser double-sided welding device further includes a second drive mechanism configured to drive the second laser welding torch to move along the length direction of the butt weld.

In an embodiment, the first length is equal to the second length.

According to an embodiment of the present application, there is further provided a laser double-sided welding method including: providing a first laser welding torch above a butt weld and aligning the first laser welding torch with an upper surface of the butt weld, and providing a second laser welding torch below the butt weld and aligning the second laser welding torch with a lower surface of the butt weld; and moving the first laser welding torch and the second laser welding torch synchronously along a length direction of the butt weld and alternatively weld the upper surface and the lower surface of the butt weld.

In an embodiment, while the first laser welding torch and the second laser welding torch move synchronously along the length direction of the butt weld, laser welding is performed by the first laser welding torch and the second laser welding torch alternatively, and a time interval of alternatively welding is zero.

In an embodiment, when welding is performed by the first laser welding torch, the second laser welding torch moves synchronously with the first laser welding torch, and the second laser welding torch stops emitting light, and when welding is performed by the second laser welding torch, the first laser welding torch moves synchronously with the second laser welding torch, and the first laser welding torch stops emitting light.

In an embodiment, welding parameters of the first laser welding torch and the second laser welding torch include a welding length, a time interval, and a welding process parameter.

### Beneficial Effects

The laser double-sided welding device provided in the present application has the following advantages compared to the prior art.

When it is necessary to weld a butt weld between a first to-be-welded test piece and a second to-be-welded test piece, a first laser welding torch is provided above the butt weld and aligned with an upper surface of the butt weld, and a second laser welding torch is provided below the butt weld and aligned with a lower surface of the butt weld. A controller will control the first laser welding torch and the second laser welding torch respectively to move synchronously along a length direction of the butt weld and alternatively weld the upper surface and the lower surface of the butt weld. It can be seen that the present application makes full use of the advantages of high penetration and deep penetration welding of the lasers in the first laser welding torch and the second laser welding torch. No groove welding is required for the first to-be-welded test piece and the second to-be-welded test piece. Therefore, square grooved welding greatly reduces welding stress under the premise of ensuring the quality of welding. Moreover, this method of double-sided alternatively welding can make the welding heat distributed symmetrically, effectively control the distribution of welding stress, make the stress distribution of welding more uniform, and form a form of double-sided symmetrical stress distribution, ensuring that the welding shrinkage and welding deformation are the same in different welding areas, and further achieving the purpose of effectively controlling the welding deformation.

### BRIEF DESCRIPTION OF THE DRAWINGS

FIG. 1 is a schematic diagram of the overall structure of a laser double-sided welding device in Embodiment 1 of the present application.

FIG. 2 is a schematic diagram of the overall structure of a laser double-sided welding device in Embodiment 2 of the present application.

FIG. 3 is a schematic flowchart of the steps of a laser double-sided welding method according to an embodiment of the present application.

In the drawings, reference signs are denoted as follows:
100: first to-be-welded test piece; 200: second to-be-welded test piece; 300: butt weld; 1: controller; 2: first laser welding torch; 3: second laser welding torch; m: first length; n: second length; 4: laser.

### DETAILED DESCRIPTION

Specific implementations of the present application are further described in detail below with reference to the accompanying drawings and embodiments. The following examples are used to illustrate the present application, but are not intended to limit the scope of the present application.

In the description of the present application, it should be noted that the terms “install”, “connect”, and “connection” should be understood in a broad sense unless expressly specified and limited otherwise. For example, it can be a fixed connection, a detachable connection, or an integral connection. It can be a mechanical connection or an electrical connection. It can be directly connected, indirectly connected through an intermediate medium, or connected internally between two elements. The specific meanings of the above terms in the present application can be understood according to specific situations for those skilled in the art.

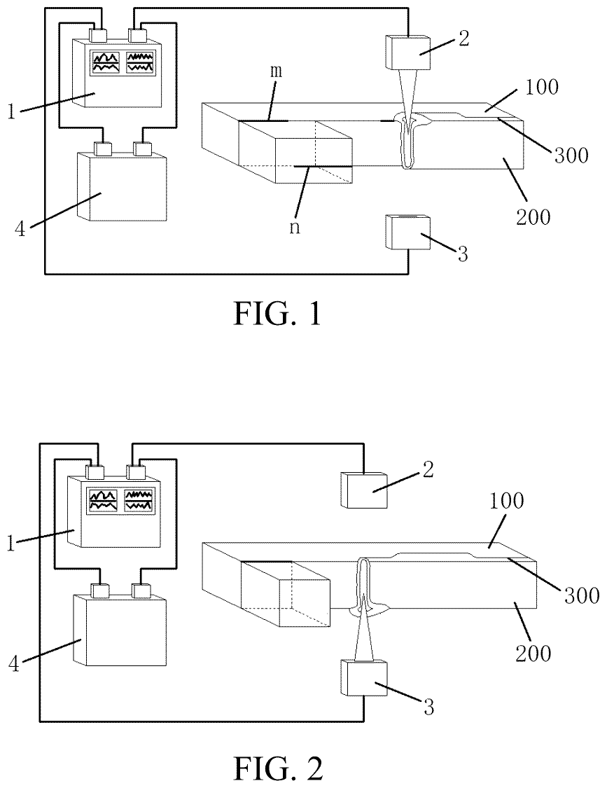

As shown in FIG. 1 and FIG. 2, a laser double-sided welding device is schematically shown to weld an upper surface and a lower surface of a butt weld 300 between a first to-be-welded test piece 100 and a second to-be-welded test piece 200 that are adjacent.

The laser double-sided welding device includes a controller 1, a first laser welding torch 2, and a second laser welding torch 3.

In the embodiment of the present application, both the first laser welding torch 2 and the second laser welding torch 3 are connected to the controller 1. The first laser welding torch 2 is provided above the butt weld 300 and aligned with the upper surface of the butt weld 300, and the second laser welding torch 3 is provided below the butt weld 300 and aligned with the lower surface of the butt weld 300. The controller 1 is configured to control the first laser welding torch 2 and the second laser welding torch 3 respectively to move synchronously along a length direction of the butt weld 300 and alternatively weld the upper surface and the lower surface of the butt weld 300. In an embodiment, when it is necessary to weld the butt weld 300 between the first to-be-welded test piece 100 and the second to-be-welded test piece 200, the first laser welding torch 2 is provided above the butt weld 300 and aligned with the upper surface of the butt weld 300, and the second laser welding torch 3 is provided below the butt weld 300 and aligned with the lower surface of the butt weld 300. The controller 1 controls the first laser welding torch 2 and the second laser welding torch 3 respectively to move synchronously along the length direction of the butt weld 300 and alternatively weld the upper surface and the lower surface of the butt weld 300. It can be seen that the present application makes full use of the advantages of high penetration and deep penetration welding of the lasers in the first laser welding torch 2 and the second laser welding torch 3. Square grooved welding is required for the first to-be-welded test piece 100 and the second to-be-welded test piece 200. Therefore, square grooved welding greatly reduces welding stress under the premise of ensuring the quality of welding. Moreover, this method of double-sided alternatively welding can make the welding heat distributed symmetrically, effectively control the distribution of welding stress, make the stress distribution of welding more uniform, and form a form of double-sided symmetrical stress distribution, ensuring that the welding shrinkage and welding deformation are the same in different welding areas, and further achieving the purpose of effectively controlling the welding deformation.

As shown in FIG. 1 and FIG. 2, in a preferred embodiment of the present application, an end point of a first length m welded by the first laser welding torch 2 along the upper surface of the butt weld 300 is a start point of a second length n welded by the second laser welding torch 3 along the lower surface of the butt weld 300. That is to say, in the welding process of the first laser welding torch 2 and the second laser welding torch 3, by determining the end point of the first length m welded by the first laser welding torch 2 along the upper surface of the butt weld 300 as the start point of the second length n welded by the second laser welding torch 3 along the lower surface of the butt weld 300, it ensures that the welding of the upper surface and the lower surface of the butt weld 300 can be continuous and uninterrupted in the welding process. Moreover, it can avoid non-uniform stress distribution during welding and ensure that the welding shrinkage and welding deformation are the same in different welding areas, thereby achieving the purpose of effectively controlling welding deformation.

As shown in FIG. 1 and FIG. 2, in a preferred embodiment of the present application, the laser double-sided welding device further includes a first welding table (not shown in the figure) and a second welding table provided adjacent to the first welding table (not shown in the figure). The first welding table is configured to place the first to-be-welded test piece 100, and the second welding table is configured to place the second to-be-welded test piece 200. The butt weld 300 between the first to-be-welded test piece 100 and the second to-be-welded test piece 200 is provided between the first welding table and the second welding table. In an embodiment, by separately adding a first welding table and a second welding table, the first welding table can be used to support the first to-be-welded test piece 100, and the second welding table can be used to support the second to-be-welded test piece 200. In addition, by providing the butt weld 300 between the first to-be-welded test piece 100 and the second to-be-welded test piece 200 between the first welding table and the second welding table, the welding of the first to-be-welded test piece 100 and the second to-be-welded test piece 200 can be conveniently realized, thereby preventing the butt weld 300 from being blocked by the first welding table or second welding table.

As shown in FIG. 1 and FIG. 2, in a preferred embodiment of the present application, the laser double-sided welding device further includes a laser 4 electrically connected to the controller 1. In an embodiment, the first laser welding torch 2 and the second laser welding torch 3 may emit laser light respectively by the arrangement of laser 4, so as to realize laser welding of the butt weld 300 between the first to-be-welded test piece 100 and the second to-be-welded test piece 200. In addition, the arrangement of laser 4 may be configured to provide laser sources for the first laser welding torch 2 and the second laser welding torch 3, respectively, so as to meet the laser welding requirements of the first laser welding torch 2 and the second laser welding torch 3.

In a preferred embodiment of the present application, the laser double-sided welding device further includes a first drive mechanism (not shown in the figure) configured to drive the first laser welding torch 2 to move along the length direction of the butt weld 300. In an embodiment, the arrangement of the first drive mechanism effectively improves the working efficiency of the first laser welding torch 2 compared to manual handheld devices.

In another preferred embodiment of the present application, the laser double-sided welding device further includes a second drive mechanism (not shown in the figure) for driving the second laser welding torch 3 to move along the length direction of the butt weld 300. In an embodiment, the arrangement of the second drive mechanism effectively improves the working efficiency of the second laser welding torch 3 compared to manual handheld devices.

In a specific embodiment, the first drive mechanism and the second drive mechanism may both be robots.

In another preferred embodiment of the present application, the first length m is equal to the second length n. In this way, it may facilitate the welding of the first laser welding torch 2 and the second laser welding torch 3. Meanwhile, it may effectively ensure that the heat on the upper surface and the lower surface of the butt weld 300 may be uniformly distributed, ensuring that the welding shrinkage and welding deformation are the same in different welding areas, further achieving the purpose of effectively controlling the welding deformation.

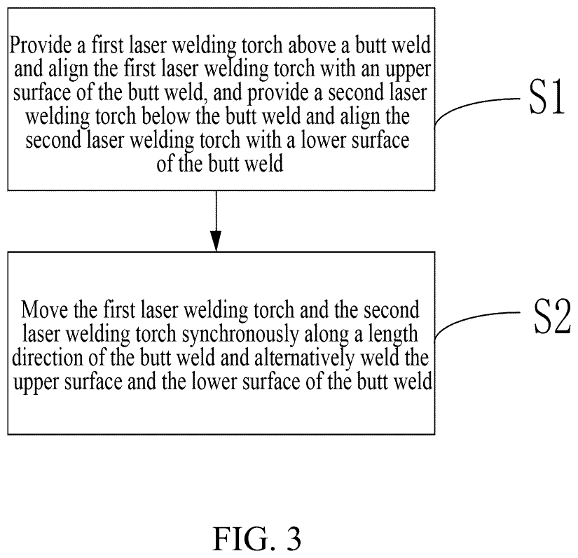

As shown in FIG. 3, according to an embodiment of the present application, there is further provided a laser double-sided welding method including the following steps.

At step S1, provide a first laser welding torch 2 above the butt weld 300 and align the first laser welding torch 2 with an upper surface of the butt weld 300, and provide a second laser welding torch 3 below the butt weld 300 and align the second laser welding torch 3 with a lower surface of the butt weld 300.

At step S2, move the first laser welding torch 2 and the second laser welding torch 3 synchronously along a length direction of the butt weld 300 and alternatively weld the upper surface and the lower surface of the butt weld 300. In an embodiment, the method of laser double-sided welding in the present application makes full use of the advantages of high penetration and deep penetration welding of the lasers, and welding can be carried out without grooving. Square grooved welding greatly reduces welding stress under the premise of ensuring the quality of welding. Moreover, this method of double-sided alternatively welding can effectively control the stress distribution of welding, and form a form of double-sided symmetrical stress distribution, thereby effectively controlling the welding deformation.

In another preferred embodiment of the present application, the first laser welding torch 2 and the second laser welding torch 3 move synchronously along the length direction of the butt weld 300, while laser welding is performed by the first laser welding torch 2 and the second laser welding torch 3 alternatively and a time interval of alternatively welding is zero. That is to say, an end point of a first length m welded by the first laser welding torch 2 along the upper surface of the length direction of the butt weld 300 is a start point of a second length n welded by the second laser welding torch 3 along the lower surface of the length direction of the butt weld 300. In the switching process between the first laser welding torch 2 and the second laser welding torch 3, the time interval is zero, ensuring that the welding of the upper surface and the lower surface of the butt weld 300 can be continuous and uninterrupted in the welding process. Moreover, it can avoid non-uniform stress distribution during welding and ensure that the welding shrinkage and welding deformation are the same in different welding areas, thereby achieving the purpose of effectively controlling welding deformation.

In another preferred embodiment of the present application, when welding is performed by the first laser welding torch 2, the second laser welding torch 3 moves synchronously with the first laser welding torch 2, and the second laser welding torch 3 stops emitting light.

When welding is performed by the second laser welding torch 3, the first laser welding torch 2 moves synchronously with the second laser welding torch 3, and the first laser welding torch 2 stops emitting light. In this way, alternatively welding the upper surface and the lower surface of the butt weld 300 can be conveniently realized, the stress distribution of the welding can be effectively controlled and a form of double-sided symmetrical stress distribution can be formed to effectively control the welding deformation.

In a specific embodiment, the welding parameters of the first laser welding torch 2 and the second laser welding torch 3 include a welding length, a time interval, and a welding process parameter. In an embodiment, each welding length is preferably ranged from 50 mm to 150 mm, and a preferred time interval is 0 seconds. Welding process parameters include a welding speed, a laser defocus, a laser power, a laser focal length, a fiber diameter, and the like. In an embodiment, the preferred welding speed is 2 m/min to 6 m/min, the laser defocus is 2 mm to 4 mm, the laser power is 1.5 kW to 7 kW, the preferred laser focal length is 300 mm, and the preferred fiber diameter is 0.4 mm.

In addition, it should be noted that both the first to-be-welded test piece 100 and the second to-be-welded test piece 200 are medium and thin plates, and a thickness range of the first to-be-welded test piece 100 and the second to-be-welded test piece 200 is 1 mm to 4 mm.

In summary, when it is necessary to weld the butt weld 300 between the first to-be-welded test piece 100 and the second to-be-welded test piece 200, the first laser welding torch 2 is provided above the butt weld 300 and aligned with the upper surface of the butt weld 300, and the second laser welding torch 3 is provided below the butt weld 300 and aligned with the lower surface of the butt weld 300. The controller 1 will control the first laser welding torch 2 and the second laser welding torch 3 respectively to move synchronously along the length direction of the butt weld 300 and perform alternatively welding on the upper surface and the lower surface of the butt weld 300. It can be seen that the present application makes full use of the advantages of high penetration and deep penetration welding of the lasers in the first laser welding torch 2 and the second laser welding torch 3. No groove welding is required for the first to-be-welded test piece 100 and the second to-be-welded test piece 200. Therefore, square grooved welding greatly reduces welding stress under the premise of ensuring the quality of welding. Moreover, this method of double-sided alternatively welding can make the welding heat distributed symmetrically, effectively control the distribution of welding stress, make the stress distribution of welding more uniform, and form a form of double-sided symmetrical stress distribution, ensuring that the welding shrinkage and welding deformation are the same in different welding areas, and further achieving the purpose of effectively controlling the welding deformation.

The above are only preferred embodiments of the present application and are not intended to limit the present application. Any modifications, equivalent substitutions, and improvements made within the principles of the present application shall fall within the protection scope of the present application.

1. A laser double-sided welding device for welding an upper surface and a lower surface of a butt weld between a first to-be-welded test piece and a second to-be-welded test piece that are adjacent, comprising:
a controller, a first laser welding torch, and a second laser welding torch,
wherein both the first laser welding torch and the second laser welding torch are connected to the controller, the first laser welding torch is provided above the butt weld and aligned with the upper surface of the butt weld, and the second laser welding torch is provided below the butt weld and aligned with the lower surface of the butt weld,
wherein the controller is configured to control the first laser welding torch and the second laser welding torch respectively to move synchronously along a length direction of the butt weld and alternatively weld the upper surface and the lower surface of the butt weld.

2. The device of claim 1, wherein an end point of a first length welded by the first laser welding torch along an upper surface of the length direction of the butt weld is a start point of a second length welded by the second laser welding torch along a lower surface of the length direction of the butt weld.

3. The device of claim 1, further comprising a first welding table and a second welding table provided adjacent to the first welding table, wherein the first welding table is configured to place the first to-be-welded test piece, and the second welding table is configured to place the second to-be-welded test piece, and wherein the butt weld between the first to-be-welded test piece and the second to-be-welded test piece is provided between the first welding table and the second welding table.

4. The device of claim 1, further comprising a laser electrically connected to the controller.

5. The device of claim 1, further comprising a first drive mechanism, wherein the first drive mechanism is configured to drive the first laser welding torch to move along the length direction of the butt weld.

6. The device of claim 1, further comprising a second drive mechanism, wherein the second drive mechanism is configured to drive the second laser welding torch to move along the length direction of the butt weld.

7. The device of claim 2, wherein the first length is equal to the second length.

8. A laser double-sided welding method, comprising:
providing a first laser welding torch above a butt weld and aligning the first laser welding torch with an upper surface of the butt weld, and providing a second laser welding torch below the butt weld and aligning the second laser welding torch with a lower surface of the butt weld; and
moving the first laser welding torch and the second laser welding torch synchronously along a length direction of the butt weld and alternatively welding the upper surface and the lower surface of the butt weld.

9. The method of claim 8, wherein, while the first laser welding torch and the second laser welding torch move synchronously along the length direction of the butt weld, laser welding is performed by the first laser welding torch and the second laser welding torch alternatively, and a time interval of alternatively welding is zero.

10. The method of claim 8, wherein, when welding is performed by the first laser welding torch, the second laser welding torch moves synchronously with the first laser welding torch, and the second laser welding torch stops emitting light; and
when welding is performed by the second laser welding torch, the first laser welding torch moves synchronously with the second laser welding torch, and the first laser welding torch stops emitting light.

11. The method of claim 8, wherein welding parameters of the first laser welding torch and the second laser welding torch comprise a welding length, a time interval, and a welding process parameter.

12. The device of claim 2, further comprising a laser electrically connected to the controller.

13. The device of claim 3, further comprising a laser electrically connected to the controller.

14. The device of claim 5, further comprising a second drive mechanism, wherein the second drive mechanism is configured to drive the second laser welding torch to move along the length direction of the butt weld.
